(19) United States
(12) Patent Application Publication
(10) Pub. No.: US 2014/0055416 A1
(43) Pub. Date: Feb. 27, 2014

(54) Optical Touch System and Operation Method Thereof

(71) Applicant: PIXART IMAGING INC., HSINCHU CITY (TW)

(72) Inventors: Ming-Tsan KAO, HSINCHU City (TW); Tzung-Min SU, HSINCHU City (TW); Chih-Hsin LIN, HSINCHU City (TW)

(73) Assignee: PIXART IMAGING INC., HSINCHU City (TW)

(21) Appl. No.: 13/773,575

(22) Filed: Feb. 21, 2013

(30) Foreign Application Priority Data
Aug. 23, 2012 (TW) 101130687

(51) Int. Cl. G06F 3/042

(52) U.S. Cl. CPC G06F 3/042
USPC 345/175

(57) ABSTRACT

An operation method of an optical touch system is provided. The optical touch system includes a touch surface, a light sensing unit, a switch unit and an analog-to-digital conversion unit. The light sensing unit includes a plurality of light sensing elements. The operation method includes: turning on one specific light sensing element group and thereby configuring the light sensing elements thereof to sense the light on the touch surface; and controlling the switch unit to electrically connect the light sensing elements of the turned-on light sensing element group to the input terminals of the analog-to-digital conversion unit, respectively, so as to transmit the sensing signals outputted from the turned-on light sensing element group to the input terminals, and thereby configuring the analog-to-digital conversion unit to generate at least one digital output signal according to the sensing signals supplied to the input terminals thereof. An optical touch system is also provided.

### TECHNICAL FIELD

The present invention relates to an optical touch technology, and more particularly to an optical touch system and an operation thereof.

### BACKGROUND

Basically, today's optical touch system performs the touch sensing by employing an image sensing device and a mirror; wherein the image sensing device is configured to sense an image of a touch surface of the optical touch system and a mirror image of the touch surface formed by the mirror. Thus, the optical touch system can, when an object is close to the touch surface, calculate the position of the object relative to the touch surface based on the image of the object and the image of the mirror image of the object in the sensed images.

However, when the object is relatively too close to the mirror, the image of the object and the image of the mirror image of the object may merge to each other in the sensed image, which may lead that the optical touch systems may not correctly calculate the actual position of the object.

### SUMMARY OF EMBODIMENTS

Therefore, one object of the present invention is to provide an optical operation system capable of determining whether or not an object is in a hover state.

The present invention provides an optical touch system capable of correctly calculating the actual position of an object.

The present invention provides an operation method of the aforementioned optical touch system.

An embodiment of the present invention provides an optical touch system, which includes a touch surface, a light sensing unit, an analog-to-digital conversion unit, a switch unit and a processing circuit. The light sensing unit is disposed on one side of the touch surface and includes a plurality of light sensing elements. The light sensing elements each are configured to sense light on the touch surface and accordingly output a sensing signal. The light sensing elements are divided into a plurality of light sensing element groups, and the light sensing element groups each include a plurality of adjacent light sensing elements. The analog-to-digital conversion unit includes a plurality of input terminals and at least one output terminal. The switch unit is electrically connected between the light sensing elements and the input terminals of the analog-to-digital conversion unit. The processing circuit is electrically connected to the output terminals of the analog-to-digital conversion unit, the switch unit and the light sensing elements and configured to turn on one of the light sensing element groups and thereby configuring the light sensing elements thereof to sense light on the touch surface, and control the switch unit to electrically connect the light sensing elements of the turned-on light sensing element group to the input terminals of the analog-to-digital conversion unit, respectively, and thereby transmitting the sensing signals outputted from the turned-on light sensing element group to the input terminals, respectively. The analog-to-digital conversion unit is configured to generate at least one digital output signal according to the sensing signals supplied to the input terminals thereof.

Another embodiment of the present invention provides an operation method of an optical touch system. The optical touch system includes a touch surface, a light sensing unit, a switch unit and an analog-to-digital conversion unit. The light sensing unit is disposed on one side of the touch surface and includes a plurality of light sensing elements, each is configured to sense light on the touch surface and accordingly output a sensing signal. The light sensing elements are divided into a plurality of light sensing element groups, and the light sensing element groups each include a plurality of adjacent light sensing elements. The analog-to-digital conversion unit includes a plurality of input terminals and at least one output terminal. The switch unit is electrically connected between the light sensing elements and the input terminals of analog-to-digital conversion unit. The operation method includes: turning on one of the light sensing element groups and thereby configuring the light sensing elements thereof to sense the light on the touch surface; and controlling the switch unit to electrically connect the light sensing elements of the turned-on light sensing element group to the input terminals of the analog-to-digital conversion unit, respectively, so as to transmit the sensing signals outputted from the turned-on light sensing element group to the input terminals, and thereby configuring the analog-to-digital conversion unit to generate at least one digital output signal according to the sensing signals supplied to the input terminals thereof.

Still another embodiment of the present invention provides an optical touch system, which includes a touch surface, at least one image sensing device, at least one image processing unit, a light sensing unit and a light sensing processing unit. The image sensing device is configured to capture a touch image of the touch surface. The image processing unit is configured to calculate a touch position of at least one object according to the captured touch image(s). The light sensing unit is disposed on at least one side of the touch surface and includes a plurality of light sensing elements. The light sensing processing unit is configured to receive a plurality of sensing signals of the respective light sensing elements according to the touch position and generate at least one touch coordinate according to the received sensing signals and the touch position.

In summary, through additionally employing a light sensing unit disposed on at least one side of a touch surface and including a plurality of light sensing elements configured to sense the light on the touch surface output and accordingly output sensing signals, the optical touch system according to the present invention can, when at least one of the light sensing element sensing an object closing to the touch surface, calculate the position of the object relative to the light sensing unit according to the sensing signals with lightness variations and consequently calculate the one-dimensional position of the object relative to the touch surface.

### BRIEF DESCRIPTION OF THE DRAWINGS

The above embodiments will become more readily apparent to those ordinarily skilled in the art after reviewing the following detailed description and accompanying drawings, in which:

FIG. 1 is a schematic view of an optical touch system in accordance with an embodiment of the present invention;

FIG. 2A is a schematic view of an optical touch system in accordance with another embodiment of the present invention;

FIG. 2B is a schematic view of an optical touch system in accordance with still another embodiment of the present invention;

FIG. 3 is a schematic flow chart illustrating an operation method of an optical touch system in accordance with an embodiment of the present invention;

FIG. 4 is a schematic view of an optical touch system in accordance with yet another embodiment of the present invention;

FIG. 5A is a schematic view illustrating an arrangement position of a light emitting unit and a light sensing element group; and

FIG. 5B is a schematic view illustrating another arrangement position of a light emitting unit and a light sensing element group.

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

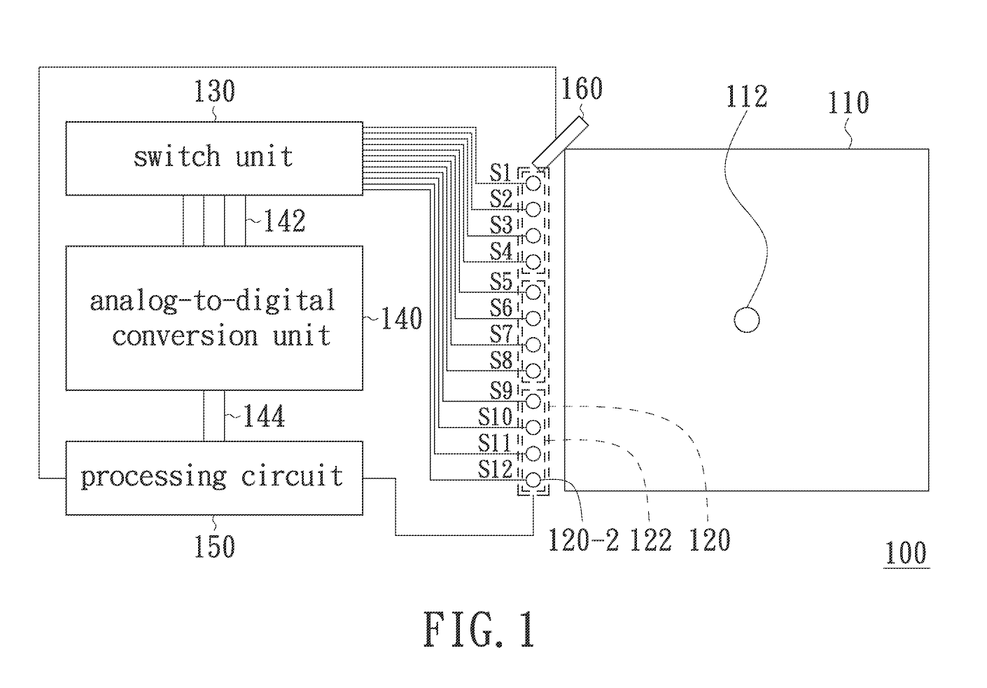

FIG. 1 is a schematic view of an optical touch system in accordance with an embodiment of the present invention. As shown, the optical touch system 100 in this embodiment includes a touch surface 110, a light sensing unit 120, a switch unit 130, an analog-to-digital conversion unit 140 and a processing circuit 150. The light sensing unit 120 is disposed on one side of the touch surface 110 and includes a plurality of light sensing elements 120-2 (herein, the light sensing unit 120 is exemplified by including twelve light sensing elements 120-2), which are configured to sense light on the touch surface 110 and accordingly output sensing signals S1˜S12, respectively. In addition, these light sensing elements 120-2 are divided into a plurality of light sensing element groups 122; in other words, the light sensing element groups 122 each include a plurality of adjacent light sensing elements 120-2. In this embodiment, the twelve light sensing elements 120-2 are divided into three light sensing element groups 122; in other words, the light sensing element groups 122 each include four adjacent light sensing elements 120-2. In one embodiment, the four light sensing signals S1˜S4 belong to one light sensing element group 122; the four light sensing signals S5˜S8 belong to another one light sensing element group 122; and the four light sensing signals S9˜S12 belong to still another one light sensing element group 122. In another embodiment, the six light sensing signals S1, S3, S5, S7, S9 and S11 belong to one light sensing element group 122; and the six light sensing signals S2, S4, S6, S8, S10 and S12 belong to another one light sensing element group 122.

The analog-to-digital conversion unit 140 includes a plurality of input terminals 142 and at least one output terminal 144. In this embodiment, the analog-to-digital conversion unit 140 is exemplified by including four input terminals 142 and two output terminals 144. The switch unit 130 is electrically connected between the light sensing elements 120-2 and the input terminals 142 of the analog-to-digital conversion unit 140. The processing circuit 150, electrically connected to the output terminals 144 of the analog-to-digital conversion unit 140, the switch unit 130 and each one of the light sensing elements 120-2, is configured to turn on one of the three light sensing element groups 122 and thereby configuring the four light sensing elements 120-2 thereof to sense light on the touch surface 110, control the switch unit 130 to electrically connect the four light sensing elements 120-2 of the aforementioned turned-on light sensing element group 122 to the four input terminals 142 of the analog-to-digital conversion unit 140, respectively, and thereby transmitting the four sensing signals S1˜S4, S5˜S8 or S9˜S12 outputted from the aforementioned turned-on light sensing element group 122 to the four input terminals 142, respectively. It is to be understood that the numbers of the input terminals 142 and the output terminals 144 of the analog-to-digital conversion unit 140 illustrated herein are used for example only; and the present invention is not limited thereto.

The analog-to-digital conversion unit 140 is configured to generate at least one digital output signal according to the four sensing signals S1˜S4, S5˜S8 or S9˜S12 supplied to the input terminals 142 thereof. In this embodiment, the analog-to-digital conversion unit 140 is exemplified by generating two digital output signals according to the four sensing signals S1˜S4, S5˜S8 or S9˜S12 respectively supplied to the four input terminals 142 thereof, and consequently configured to transmit the two digital output signals to the processing circuit 150 via the two output terminals 144 thereof, respectively. Therefore, after sequentially receiving the digital output signals outputted from the light sensing element groups 122 from the analog-to-digital conversion unit 140, the processing circuit 150 can calculate the position of the object 112 relative to the light sensing unit 120 based on the received digital output signals.

In addition, the optical touch system 100 may further include an image sensing device 160, which is electrically connected to the processing circuit 150 and configured to capture images of the object 112. In this embodiment, the processing circuit 150 is further configured to calculate the coordinate of the object 112 relative to the touch surface 110 according to the images captured by the image sensing device 160. Additionally, in this embodiment, the processing circuit 150 is further configured to adjust the aforementioned calculated coordinate according to the position of the object 112 relative to the light sensing unit 120 previously obtained based on the sensing signals S1˜S12. In this embodiment, the image sensing device 160 is configured to equip with a light emitting device, which is configured to emit light to illuminate the object 112. Therefore, the processing circuit 150 can find the light spot(s), resulted from the light reflected by the object 112, in the image captured by the image sensing device 160, refer the light spot(s) to as the image of the object 112 and accordingly calculate the coordinate of the object 112 relative to the touch surface 110. And in another embodiments, the touch surface 110 can further have at least a light guide strip equipped around at least one side of the touch surface 110 to provide a brilliant background in the captured image, and therefore the processing circuit 150 can find dark spot(s) resulted from the shielding of light by the object 112 and also the light emitting device can be eliminated.

In one embodiment, the processing circuit 150 is configured to calculate the coordinate of the object 112 relative to the touch surface 110 first and then turn on the light sensing element group 122, corresponding to the aforementioned calculated coordinate, and thereby configuring the light sensing elements 120-2 thereof to sense the light on the touch surface 110. In another embodiment, the processing circuit 150 is configured to turn on one specific light sensing element group 122 and thereby configuring the light sensing elements 120-2 thereof to sense the light on the touch surface 110 simultaneously while receiving the image of the object 112 captured by the image sensing device 160; wherein the specific light sensing element group 122 to be turned on is determined by the coordinate of the object 112 calculated previously. In still another embodiment, the processing circuit 150 is configured to, after receiving the first image from the image sensing device 160, sequentially turn on the three light sensing element groups 122 and thereby configuring the light sensing elements 120-2 thereof to sense the light on the touch surface 110. In some other embodiments, some of the twelve light sensing elements 120-2 in different light sensing element group 122 are configured to corporately electrically connect to one of the four output terminals 142 of the analog-to-digital conversion unit 140 via the switch unit 130 so as to detect an approximate position of the object 112 rapidly. In addition, one same light sensing element 120-2 may belong to two different but adjacent light sensing element groups 122; in other words, two adjacent light sensing element groups 122 each may include the same light sensing element(s) 120-2.

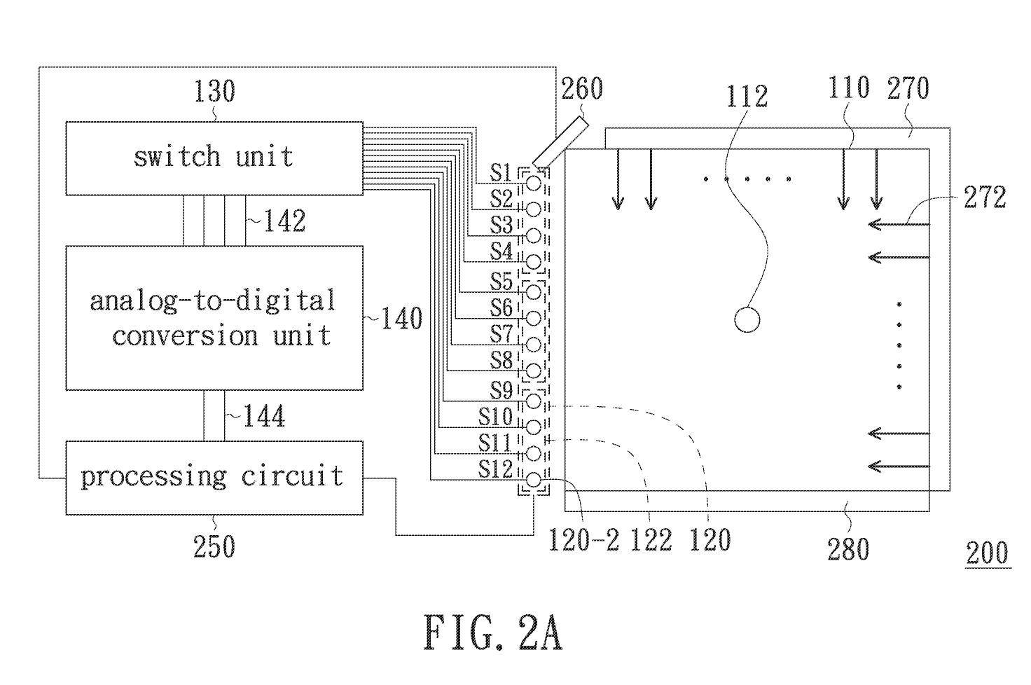

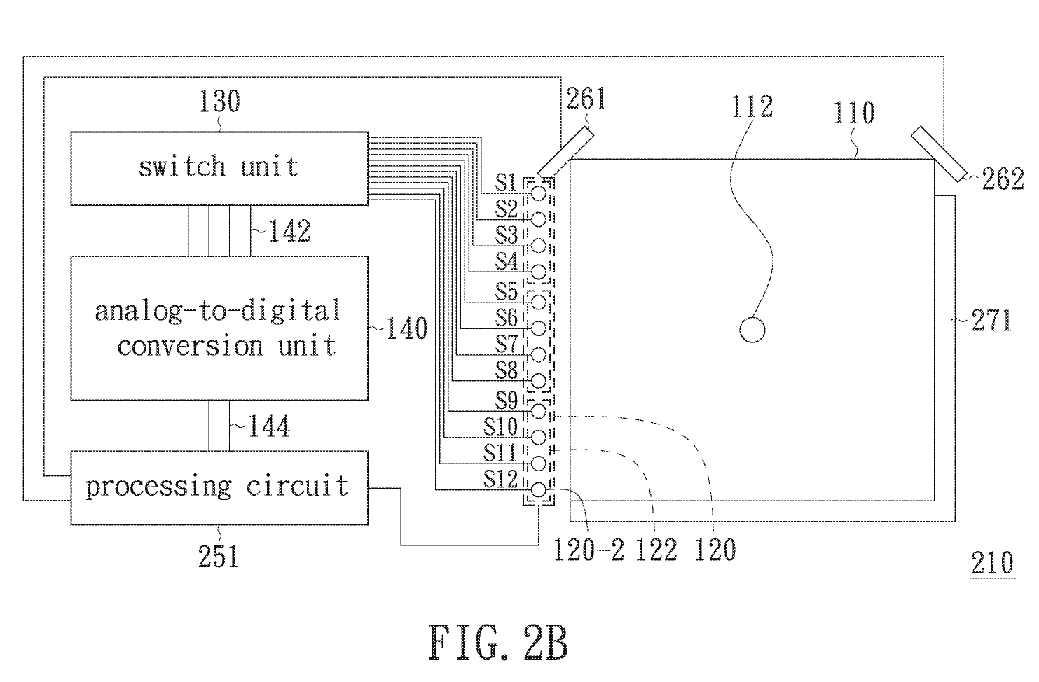

FIG. 2A is a schematic view of an optical touch system in accordance with another embodiment of the present invention. The main difference between the optical touch system 200 in this embodiment and the aforementioned optical touch system 100 is that the optical touch system 200 further includes a light emitting unit 270 and a reflective unit 280. In addition, the processing circuit 250 in the optical touch system 200 is configured to have an operation different to that of the processing circuit 150 in the optical touch system 100; and the image sensing device 260 in the optical touch system 200 is configured to have some specific functions different to that of the image sensing device 160 in the optical touch system 100. Specifically, the light emitting unit 270 is disposed on one side of the touch surface 110 (herein, the light emitting unit 270 is exemplified by being disposed on two adjacent sides of the touch surface 110) and configured to emit light toward the touch surface 110. The reflective unit 280 is disposed on one side of the touch surface 110 and configured to reflect light to the touch surface 110. In this embodiment, the reflective unit 280 is realized by a mirror; and the light emitting unit 270 is a light guide element, which is configured to emit linear light sources 272 by arranging a light source on a side of a light guide bar (not shown).

Because the employment of the light emitting unit 270, the image sensing device 260 in the optical touch system 200 is not required to equip with any light emitting device for emitting light to illuminate the object 112. In this embodiment, the processing circuit 250 is configured to find two dark spots, resulted from the light shielded by the object 112 as well as the mirror image thereof, in the image captured by the image sensing device 260, refer one dark spot to as the image of the object 112, and refer the other dark spot to as the image of the mirror image of the object 112. In other words, the processing circuit 250 can obtain the image of the object 112 and the image of the mirror image of the object 112 through the image sensing device 260. Thus, after obtaining the image of the object 112 and the image of the mirror image of the object 112 from the image sensing device 260, the processing circuit 250 can calculate the coordinate of the object 112 relative to the touch surface 110 according to the two obtained images; and consequently, the processing circuit 250 can adjust the calculated coordinate according to the position of the object 112 relative to the light sensing unit 120 obtained from the sensing signals S1˜S12. In a preferred embodiment, the light emitting unit 270 is disposed on two adjacent sides of the touch surface 110 as illustrated in FIG. 2A; wherein one is the side adjacent to the image sensing device 260 but not adjacent to the light sensing unit 120, and the other one is the side far away the light sensing unit 120. Thus, through the aforementioned arrangement of the light emitting unit 270, the image sensing device 260 and the light sensing unit 120 both can detect the obscured image of the object 112. In another embodiment, it is understood that the light emitting unit 270 can be replaced by the reflective unit 280; and accordingly the image sensing device 260 is required to equip with a light emitting device, which is configured to emit light to illuminate the object 112.

Likewise, in one embodiment, the processing circuit 250 is configured to calculate the coordinate of the object 112 relative to the touch surface 110 first and then turn on the light sensing element group 122, corresponding to the aforementioned calculated coordinate, and thereby configuring the light sensing elements 120-2 thereof to sense the light on the touch surface 110. In another embodiment, the processing circuit 250 is configured to turn on one specific light sensing element group 122 and thereby configuring the light sensing elements 120-2 thereof to sense the light on the touch surface 110 simultaneously while receiving the image of the object 112 and the image of the mirror image of the object 112 captured by the image sensing device 260; wherein the specific light sensing element group 122 to be turned on is determined by the coordinate of the object 112 calculated previously. In still another embodiment, the processing circuit 250 is configured to, after receiving the first image from the image sensing device 260, sequentially turn on the three light sensing element groups 122 and thereby configuring the light sensing elements 120-2 to sense the light on the touch surface 110. In addition, it is understood that the employment of the light emitting unit 270 is based on the actual circuit design of the optical touch system 200.

FIG. 2B is a schematic view of an optical touch system in accordance with still another embodiment of the present invention. The main difference between the optical touch system 210 in this embodiment and the aforementioned optical touch system 100 is that the optical touch system 210 further includes a light guide module 271 and employs two image sensing devices 261, 262. In addition, the processing circuit 251 in the optical touch system 210 is configured to have an operation different to that of the processing circuit 150 in the optical touch system 100. Specifically, the light guide module 271 is disposed on at least two adjacent sides of the touch surface 110. In this embodiment, the light sensing element groups 122 in the optical touch system 210 may be further disposed with the light guide module 271; wherein the light guide module 271 is disposed on the top of the light sensing element groups 122 in one embodiment, or, the light guide module 271 is disposed on the bottom of the light sensing element groups 122 in another embodiment. In other embodiments, the light sensing element groups 122 may be set on the side between the two image sensing devices 261, 262, and the rest three sides are disposed with three light guide modules 271.

The image sensing devices 261, 262 both are electrically connected to the processing circuit 251 and configured to capture images of the object 112. Thus, the processing circuit 251 can calculate the coordinate of the object 112 relative to the touch surface 110 according to the images captured by the image sensing devices 261, 262 and consequently adjust the calculated coordinate according to the position of the object 112 relative to the light sensing unit 120 obtained from the sensing signals S1˜S12. In one embodiment, the object 112 can shield light emitted from the light guide modules 271, so that the processing circuit 150 can find dark points, resulted from the light shielding by the object 112, in the images captures by the image sensing devices 261, 262, refer the light spot(s) to as the image of the object 112, and accordingly calculate the coordinate of the object 112. In one embodiment, the image sensing devices 261, 262 both are configured to equip with a light emitting device, which is configured to emit light to illuminate the object 112. Therefore, the processing circuit 150 can find the light spot(s), resulted from the light reflected by the object 112, in the images captured by the image sensing devices 261, 262, refer the light spot(s) to as the image of the object 112, and accordingly calculate the coordinate of the object 112.

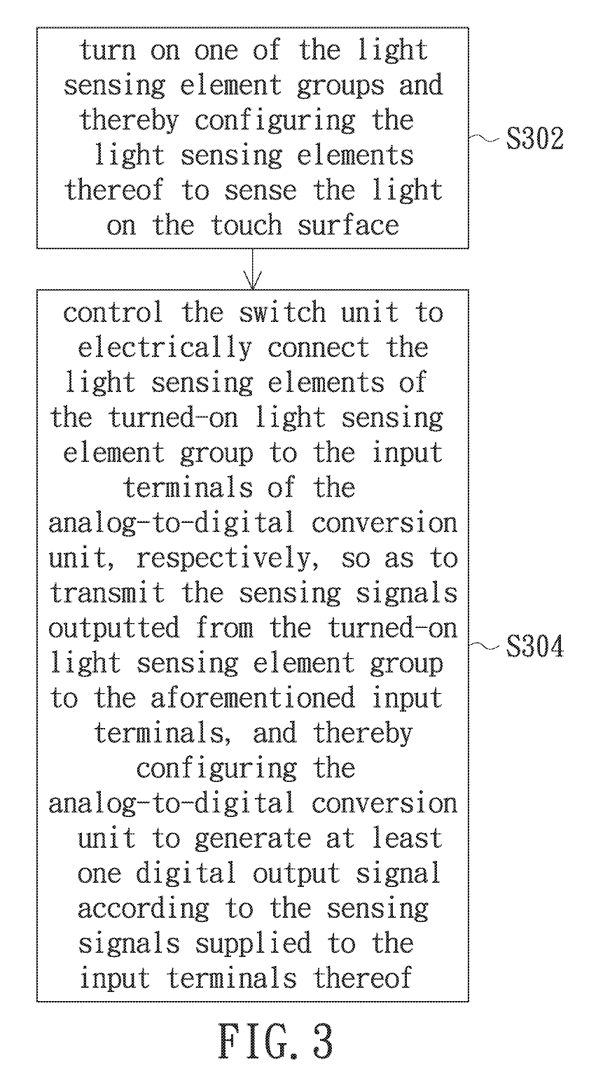

According to the aforementioned descriptions, an operation method of an optical touch system can be summarized from the embodiments of optical touch system as illustrated in FIG. 3, which is a flow chart illustrating an operation method of an optical touch system in accordance with an embodiment of the present invention.

Specifically, the optical touch system used with the operation method in this embodiment includes a touch surface, a light sensing unit, a switch unit and an analog-to-digital conversion unit. The light sensing unit is disposed on one side of the touch surface and includes a plurality of light sensing elements, each are configured to sense light on the touch surface and accordingly output a sensing signal. In addition, these light sensing elements are divided into a plurality of light sensing element groups; in other words, the light sensing element groups each include a plurality of adjacent light sensing elements. The analog-to-digital conversion unit includes a plurality of input terminals and at least one output terminal. The switch unit is electrically connected between the light sensing unit and the input terminals of analog-to-digital conversion unit. The operation method includes steps of: turning on one of the light sensing element groups and thereby configuring the light sensing elements thereof to sense the light on the touch surface (step S302); controlling the switch unit to electrically connect the light sensing elements of the turned-on light sensing element group to the input terminals of the analog-to-digital conversion unit, respectively, so as to transmit the sensing signals outputted from the turned-on light sensing element group to the aforementioned input terminals, and thereby configuring the analog-to-digital conversion unit to generate at least one digital output signal according to the sensing signals supplied to the input terminals thereof (step S304). Thus, the position of an object relative to the light sensing unit can be calculated based on the digital output signal(s).

It is understood that the optical touch system may further include an image sensing device, a light emitting unit and a reflective unit. The reflective unit can be realized by a mirror. Accordingly, the aforementioned operation method of an optical touch system may further include steps of: obtaining an image of the object and an image of the mirror image of the object via the image sensing device and thereby calculating the coordinate of the object relative to the touch surface; and adjusting the calculated coordinate according to the position of the object relative to the light sensing unit.

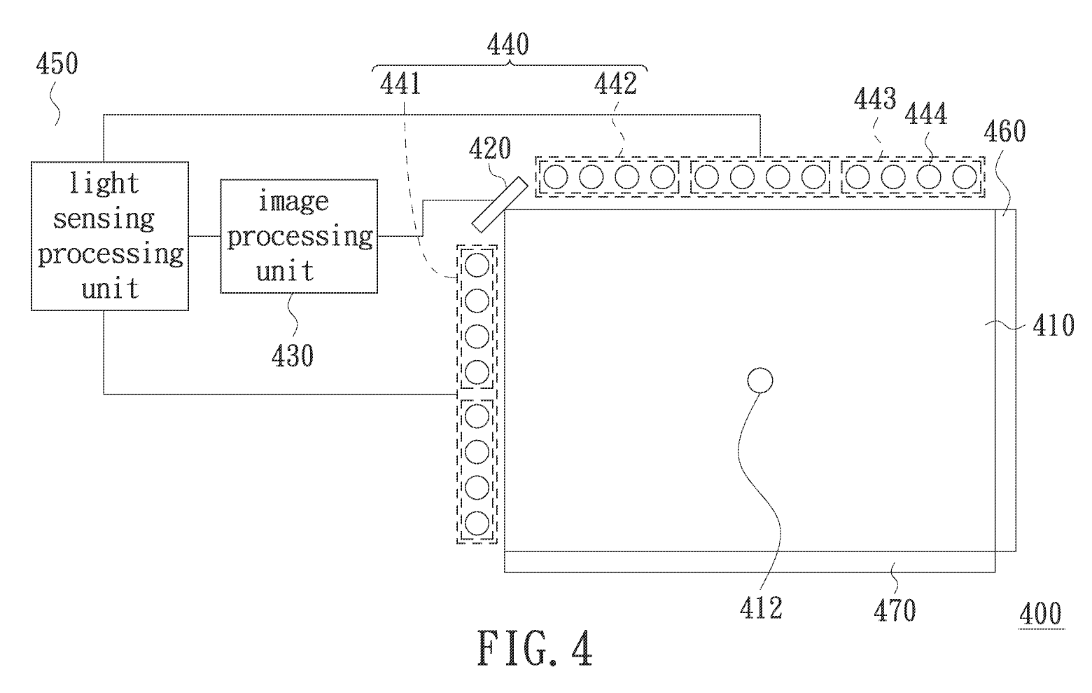

FIG. 4 is a schematic view of an optical touch system in accordance with yet another embodiment of the present invention. As shown, the optical touch system 400 in this embodiment includes a touch surface 410, an image sensing device 420, an image processing unit 430, a light sensing unit 440 and a light sensing processing unit 450. The image sensing device 420 is configured to capture the touch images of the touch surface 410. The image processing unit 430 is electrically connected to the image sensing device 420 and configured to calculate the touch position of an object 412 relative to the touch surface 410 according to the touch images captured by the image sensing device 420. The light sensing unit 440 includes a first portion 441 and a second portion 442. The first portion 441 and the second part 442 both include a plurality of light sensing elements 443; and the light sensing elements 443 each are configured to sense light on the touch surface 410 and accordingly output a sensing signal. The light sensing unit 440 is disposed on two sides of the touch surface 410. The light sensing processing unit 450, electrically connected to the image processing unit 430 and each one of the light sensing elements 443, is configured to receive a plurality of sensing signals generated by the respective light sensing elements 443 according to the aforementioned touch position calculated by the image processing unit 430 and generate a touch coordinate according to the received sensing signals and the aforementioned touch position.

The optical touch system 400 may further include a light emitting unit 460 and a reflective unit 470. The light emitting unit 460 is disposed on one side of the touch surface 410 and configured to emit light toward the touch surface 410. The reflective unit 470 is disposed on another side of the touch surface 410 and configured to reflect light to the touch surface 410. It is to be noted that the employment of the light emitting unit 460 and the reflective unit 470 is based on the actual circuit design of the optical touch system 400. In other words, the light emitting unit 460 and the reflective unit 470 are not necessarily employed in the optical touch system 400 if the image sensing device 420 is configured to equip with a light emitting device; alternatively, the light emitting unit 460 and the reflective unit 470 are necessarily employed in the optical touch system 400 if the image sensing device 420 is configured not to equip with a light emitting device. In this embodiment, the light emitting unit 460 can be replaced by the reflective unit 470 if the image sensing device 420 is configured to equip with a light emitting device, which is configured to emit light to illuminate the object 412.

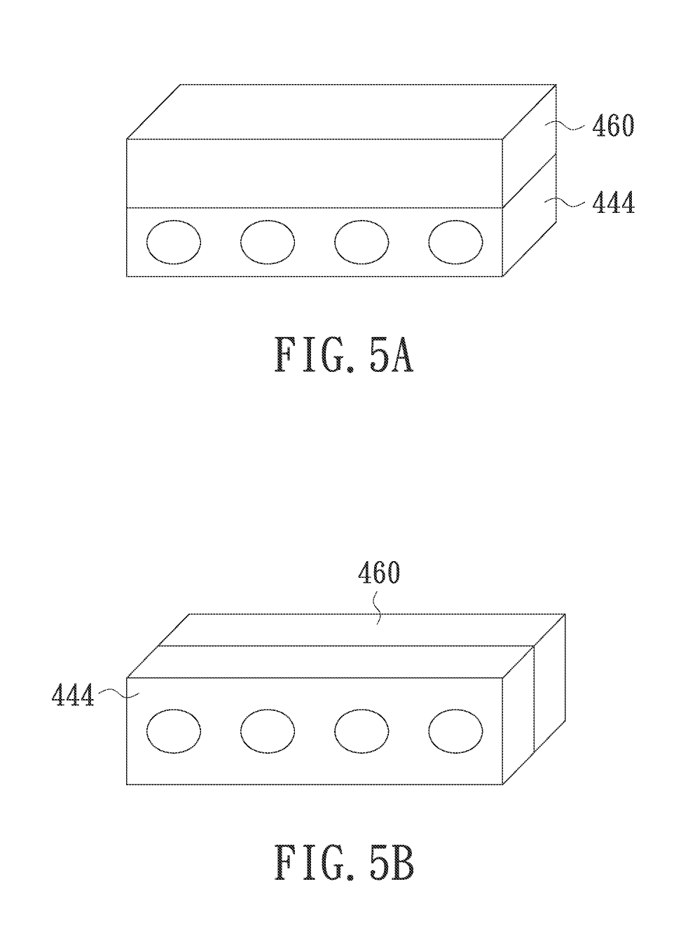

In this embodiment, the light sensing elements 443 in the light sensing unit 440 are divided into a plurality of light sensing element groups 444; in other words, the light sensing element groups 444 each include a plurality of adjacent light sensing elements 443. It is to be noted that some of the light sensing elements 443 may belong to two different but adjacent light sensing element groups 444; in other words, the two adjacent light sensing element groups 444 may include the same light sensing element(s) 443. In one embodiment, the optical touch system 400 may include two image sensing devices 420; and it is understood that the number of the image processing unit 430 in the optical touch system 400 is required to be adjusted correspondingly. The light sensing unit 440 is disposed on at least one side of the touch surface 410. In addition, if two or more objects 412 are being sensed by the optical touch system 400, the image processing unit 430 accordingly generates a corresponding number of touch positions and the light sensing processing unit 450 accordingly generates a corresponding number of touch coordinates. In some embodiments, the light emitting unit 460 or the reflective unit 470 may be also disposed at the position of the second portion 442 of the light sensing unit 440; and the image sensing device 420 is configured to equip with a light emitting device, which is configured to emit light to illuminate the object 412. Specifically, if the light emitting unit 460 is also disposed at the position of the second portion 442 of the light sensing unit 440, the light emitting unit 460 is disposed on the top of the light sensing element groups 444 in one embodiment as illustrated in FIG. 5A; or, the light sensing element groups 444 are disposed on the top of the light emitting unit 460 in another embodiment (not illustrated); or, the light emitting unit 460 is disposed in front of the light sensing element groups 444 in still another embodiment as illustrated in FIG. 5B; or, the light emitting unit 460 is disposed in the back of the light sensing element groups 444 in yet another embodiment (not illustrated).

In summary, through additionally employing a light sensing unit disposed on at least one side of a touch surface and including a plurality of light sensing elements configured to sense the light on the touch surface output and accordingly output sensing signals, the optical touch system according to the present invention can, when at least one of the light sensing element sensing an object closing to the touch surface, calculate the position of the object relative to the light sensing unit according to the sensing signals with lightness variations and consequently calculate the one-dimensional position of the object relative to the touch surface.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical touch system, comprising:
a touch surface;
a light sensing unit disposed on one side of the touch surface and comprising a plurality of light sensing elements, the light sensing elements each being configured to sense light on the touch surface and accordingly output a sensing signal, the light sensing elements being divided into a plurality of light sensing element groups, the light sensing element groups each comprising a plurality of adjacent light sensing elements;
an analog-to-digital conversion unit comprising a plurality of input terminals and at least one output terminal;
a switch unit electrically connected between the light sensing elements and the input terminals of the analog-to-digital conversion unit; and
a processing circuit electrically connected to the output terminals of the analog-to-digital conversion unit, the switch unit and the light sensing elements and configured to turn on one of the light sensing element groups and thereby configuring the light sensing elements thereof to sense light on the touch surface, and control the switch unit to electrically connect the light sensing elements of the turned-on light sensing element group to the input terminals of the analog-to-digital conversion unit, respectively, and thereby transmitting the sensing signals outputted from the turned-on light sensing element group to the input terminals, respectively;
wherein the analog-to-digital conversion unit is configured to generate at least one digital output signal according to the sensing signals supplied to the input terminals thereof.

2. The optical touch system according to claim 1, wherein the processing circuit is further configured to calculate a position of an object on the touch surface relative to the light sensing unit according to the digital output signal(s) generated by the analog-to-digital conversion unit.

3. The optical touch system according to claim 2, further comprising:
an image sensing device electrically connected to the processing circuit and configured to capture an image of the object and transmit the image of the object to the processing circuit;
wherein the processing circuit is further configured to calculate a coordinate of the object relative to the touch surface according to the image of the object captured by the image sensing device and adjust the calculated coordinate according to the position of the object relative to the light sensing unit.

4. The optical touch system according to claim 3, wherein the processing circuit is configured to calculate the coordinate of the object relative to the touch surface first and then turn on the light sensing element group, corresponding to the calculated coordinate, and thereby configuring the light sensing elements thereof to sense the light on the touch surface.

5. The optical touch system according to claim 3, wherein the processing circuit is configured to turn on one specific light sensing element group and thereby configuring the light sensing elements thereof to sense the light on the touch surface simultaneously while receiving the image of the object captured by the image sensing device.

6. The optical touch system according to claim 5, wherein the specific light sensing element group to be turned on is determined by the coordinate of the object calculated previously.

7. The optical touch system according to claim 6, wherein the processing circuit is configured to, after receiving a first image from the image sensing device, sequentially turn on the light sensing element groups and thereby configuring the light sensing elements thereof to sense the light on the touch surface.

8. The optical touch system according to claim 2, further comprising:
a light emitting unit disposed on one side of the touch surface and configured to emit light toward the touch surface.

9. The optical touch system according to claim 8, further comprising:
a reflective unit disposed on one side of the touch surface and configured to reflect light to the touch surface.

10. The optical touch system according to claim 9, wherein the reflective unit comprises a mirror.

11. The optical touch system according to claim 10, further comprising:
an image sensing device electrically connected to the processing circuit and configured to capture an image of the object and an image of the mirror image of the object and transmit the image of the object and the image of the mirror image of the object to the processing circuit;
wherein the processing circuit is further configured to calculate a coordinate of the object relative to the touch surface according to the image of the object and the image of the mirror image of the object captured by the image sensing device and adjust the calculated coordinate according to the position of the object relative to the light sensing unit

12. The optical touch system according to claim 11, wherein the processing circuit is configured to calculate the coordinate of the object relative to the touch surface first and then turn on the light sensing element group, corresponding to the calculated coordinate, and thereby configuring the light sensing elements thereof to sense the light on the touch surface.

13. The optical touch system according to claim 11, wherein the processing circuit is configured to turn on one specific light sensing element group and thereby configuring the light sensing elements thereof to sense the light on the touch surface simultaneously while receiving the image of the object and the image of the mirror image of the object captured by the image sensing device

14. The optical touch system according to claim 13, wherein the specific light sensing element group to be turned on is determined by the coordinate of the object calculated previously.

15. The optical touch system according to claim 14, wherein the processing circuit is configured to, after receiving a first image from the image sensing device, sequentially turn on the light sensing element groups and thereby configuring the light sensing elements thereof to sense the light on the touch surface.

16. The optical touch system according to claim 1, wherein some of the light sensing elements of the light sensing element group(s) are corporately electrically connected to one of the input terminals of the analog-to-digital conversion unit.

17. The optical touch system according to claim 1, wherein each two adjacent light sensing element groups may have the same light sensing element(s).

18. An operation method of an optical touch system, the optical touch system comprising a touch surface, a light sensing unit, a switch unit and an analog-to-digital conversion unit, the light sensing unit being disposed on one side of the touch surface and comprising a plurality of light sensing elements, each being configured to sense light on the touch surface and accordingly output a sensing signal, the light sensing elements being divided into a plurality of light sensing element groups, the light sensing element groups each comprising a plurality of adjacent light sensing elements, the analog-to-digital conversion unit comprising a plurality of input terminals and at least one output terminal, the switch unit being electrically connected between the light sensing elements and the input terminals of analog-to-digital conversion unit, the operation method comprising:
turning on one of the light sensing element groups and thereby configuring the light sensing elements thereof to sense the light on the touch surface; and
controlling the switch unit to electrically connect the light sensing elements of the turned-on light sensing element group to the input terminals of the analog-to-digital conversion unit, respectively, so as to transmit the sensing signals outputted from the turned-on light sensing element group to the input terminals, and thereby configuring the analog-to-digital conversion unit to generate at least one digital output signal according to the sensing signals supplied to the input terminals thereof.

19. The operation method according to claim 18, further comprising:
calculating a position of an object on the touch surface relative to the light sensing unit according to the digital output signal(s).

20. The operation method according to claim 19, wherein the optical touch system further comprises an image sensing device and the operation method further comprises:
obtaining an image of the object through the image sensing device and thereby calculating a coordinate of the object relative to the touch surface; and
adjusting the calculated coordinate according to the position of the object relative to the light sensing unit.

21. The operation method according to claim 20, wherein the coordinate of the object relative to the touch surface is calculated first and then the light sensing element group, corresponding to the calculated coordinate, is turned on and thereby configuring the light sensing elements thereof to sense the light on the touch surface.

22. The operation method according to claim 20, wherein one specific light sensing element group is turned on and thereby configuring the light sensing elements thereof to sense the light on the touch surface simultaneously while the image of the object captured by the image sensing device is being received from the image sensing device.

23. The operation method according to claim 22, wherein the specific light sensing element group to be turned on is determined by the previously-calculated coordinate of the object.

24. The operation method according to claim 23, wherein the light sensing element groups are sequentially turned on and thereby configuring the light sensing elements thereof to sense the light on the touch surface after a first image is received from the image sensing device.

25. The operation method according to claim 19, wherein the optical touch system further comprises an image sensing device, a light emitting unit and a reflective unit, the light emitting unit is disposed on one side of the touch surface and configured to emit light toward the touch surface, the reflective unit is disposed on one side of the touch surface and configured to reflect light to the touch surface, the reflective unit comprises a mirror, the operation method further comprises:
obtaining an image of the object and an image of the mirror image of the object via the image sensing device and thereby calculating a coordinate of the object relative to the touch surface; and
adjusting the calculated coordinate according to the position of the object relative to the light sensing unit.

26. The operation method according to claim 25, wherein the coordinate of the object relative to the touch surface is calculated first and then the light sensing element group, corresponding to the calculated coordinate, is turned on and thereby configuring the light sensing elements thereof to sense the light on the touch surface.

27. The operation method according to claim 25, wherein one specific light sensing element group is turned on and thereby configuring the light sensing elements thereof to sense the light on the touch surface simultaneously while the image of the object and the image of the mirror image of the object captured by the image sensing device are being received from the image sensing device.

28. The operation method according to claim 27, wherein the specific light sensing element group to be turned on is determined by the previously-calculated coordinate of the object.

29. The operation method according to claim 28, wherein the light sensing element groups are sequentially turned on and thereby configuring the light sensing elements thereof to sense the light on the touch surface after a first image is received from the image sensing device.

30. An optical touch system, comprising:
a touch surface;
at least one image sensing device configured to capture a touch image of the touch surface;
at least one image processing unit configured to calculate a touch position of at least one object according to the captured touch image(s);
a light sensing unit disposed on at least one side of the touch surface and comprising a plurality of light sensing elements; and
a light sensing processing unit configured to receive a plurality of sensing signals of the respective light sensing elements according to the touch position and generate at least one touch coordinate according to the received sensing signals and the touch position.

31. The optical touch system according to claim 30, further comprising:
a light emitting unit disposed on one side of the touch surface and configured to emit light toward the touch surface.

32. The optical touch system according to claim 31, further comprising:
a reflective unit disposed on one side of the touch surface and configured to reflect light to the touch surface.

33. The optical touch system according to claim 30, wherein the light sensing elements are divided into a plurality of light sensing element groups, and the light sensing element groups each comprise a plurality of adjacent light sensing elements.

34. The optical touch system according to claim 33, wherein each two adjacent light sensing element groups comprises the same light sensing element(s).
